(19) United States
(12) Patent Application Publication
(10) Pub. No.: US 2013/0000583 A1
(43) Pub. Date: Jan. 3, 2013

(54) LIQUID FUEL COMPOSITIONS

(76) Inventors: Adrian Philip Groves, Hamburg (DE); Clive Richard McDonald, Chester Cheshire (GB); Susan Jane Smith, Chester Cheshire (GB)

(21) Appl. No.: 13/518,174

(22) PCT Filed: Dec. 24, 2010
(86) PCT No.: PCT/EP2010/070723

§ 371 Date: Aug. 23, 2012

(30) Foreign Application Priority Data
Dec. 24, 2009 (EP) 09180735.4

(51) Int. Cl. C10L 1/222; C10M 169/04; F02B 47/04

(52) U.S. Cl. 123/1 A; 44/434; 508/562

(57) ABSTRACT

The present invention provides a liquid fuel composition comprising:—a base fuel suitable for use in an internal combustion engine; and—one or more polyetheramines having formula (I): wherein R is an —NR¹₂ group where R¹ is independently selected from hydrogen and a C₁-C₆ hydrocarbyl group, n is an integer in the range of from 6 to 37, m is an integer in the range of from 12 to 74 and p is 0 or 1. The liquid fuel composition provides improved lubricity and improved fuel economy benefits.

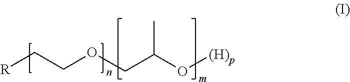

### FIELD OF THE INVENTION

The present invention relates to liquid fuel compositions comprising a major portion of a base fuel suitable for use in an internal combustion engine, in particular liquid fuel compositions comprising a major portion of a base fuel suitable for use in an internal combustion engine and a hyperdispersant.

### BACKGROUND OF THE INVENTION

EP 0164817 A2 discloses a surfactant comprising a carboxylic acid ester or amide carrying a terminal strong acid group selected from carboxylic acid, carboxymethyl, sulphate, sulphonate, phosphate and phosphonate, suitable for stabilising dispersions of solids in organic liquids and oil/water emulsions. A preferred species of the surfactant is a poly(hydroxyalkanecarboxylic acid) having the strong acid group attached, either directly or through a linking group, to a terminal hydroxy or carboxylic acid group. The use of such surfactants in fuels is not disclosed therein.

EP 0233684 A1 discloses an ester or polyester having (i) a terminal group containing at least two aliphatic carbon-carbon double bonds and (ii) an acidic or basic amino group which is suitable for use as a dispersant for solids in organic liquids. The use of such surfactants in fuels is not disclosed therein.

GB 2197312 A discloses oil soluble dispersant additives, wherein said dispersant additives are poly (C₅-C₉ lactone) adducts which have been prepared by first reacting a C₅-C₉ lactone with a polyamine, a polyol or an amino alcohol to form an intermediate adduct, whereafter the intermediate adduct is reacted with an aliphatic hydrocarbyl monocarboxylic or dicarboxylic acylating agent having from about 1 to about 165 total carbon atoms. The use of the dispersant additives in lubricating oils and fuels is also disclosed in GB 2197312 A.

EP 0802255 A2 discloses hydroxyl group containing acylated nitrogen compounds which are useful as low chlorine containing additives for lubricating oils and normally liquid fuels and a process for preparing the compounds.

WO 00/34418 A1 discloses the use of poly(hydroxycarboxylic acid)amide or -ester derivatives in fuel compositions as a lubricity additive. It is also disclosed in WO 00/34418 A1 that the use of the poly(hydroxycarboxylic acid)amide or -ester derivatives disclosed therein may also result in attaining one or more of a number of effects such as inlet system cleanliness (intake valves, fuel injectors, carburetors), combustion chamber cleanliness (in each case either or both of keep clean and clean-up effects), anti-corrosion (including anti-rust) and reduction or elimination of valve-stick. Benefits in terms of improved fuel economy and improved lubricant performance are not disclosed in WO 00/34418 A1.

US 2009/0307965 A1 discloses a fuel additive concentrate comprising a polyetheramine, antioxidant and a specified friction modifier. The concentrate is proposed for use in a hydrocarbon base fuel or in a blend of ethanol and gasoline having a ratio from 25:75 to 90:10. No technical effect is demonstrated for this combination of additives in either fuel composition.

U.S. Pat. No. 4,518,435 A discloses a dispersion of a particulate solid in a polar organic medium utilising a dispersing agent which is a tertiary amine, or salt thereof, the amine containing at least one polymeric group which is a poly(lower alkylene oxy)chain. The particulate solid is suitably selected from organic pigments, organic dyestuffs and carbon black; where an inorganic pigment is used, the polar organic medium is most suitably a lower alkanol. These dispersions find use in the preparation of inks, particularly printing inks for use in package printing. There is no suggestion that such dispersions could be used in or as a fuel composition.

It has now surprisingly been found that the use of certain polyetheramines in liquid fuel compositions can provide benefits in terms of improved fuel economy and improved engine lubricant performance.

### SUMMARY OF THE INVENTION

According to the present invention there is provided a liquid fuel composition comprising:
a base fuel suitable for use in an internal combustion engine; and
one or more polyetheramines having formula (I):

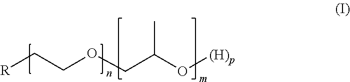

wherein R is an —NR¹₂ group where R¹ is independently selected from hydrogen and a C₁-C₆ hydrocarbyl group, n is an integer in the range of from 6 to 37, m is an integer in the range of from 12 to 74 and p is 0 or 1.

According to the present invention there is further provided a lubricating composition comprising:
a base oil; and
one or more polyetheramines having formula (I):

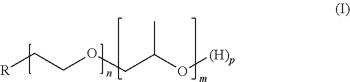

wherein R is an —NR¹₂ group where R¹ is independently selected from hydrogen and a C₁-C₆ hydrocarbyl group, n is an integer in the range of from 6 to 37, m is an integer in the range of from 12 to 74 and p is 0 or 1.

The present invention further provides a method of improving the fuel economy performance of a liquid base fuel suitable for use in an internal combustion engine, comprising admixing one or more polyetheramines having formula (I):

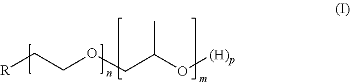

wherein R is an —NR¹₂ group where R¹ is independently selected from hydrogen and a C₁-C₆ hydrocarbyl group, n is an integer in the range of from 6 to 37, m is an integer in the range of from 12 to 74 and p is 0 or 1, with a major portion of the liquid base fuel suitable for use in an internal combustion engine.

The present invention further provides a method of improving the performance of the lubricant of an internal combustion engine, said method comprising fuelling an internal combustion engine containing the engine lubricant with a liquid fuel composition comprising:
a base fuel suitable for use in an internal combustion engine; and
one or more polyetheramines having formula (I):

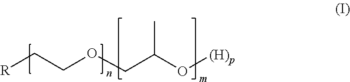

wherein R is an —NR¹₂ group where R¹ is independently selected from hydrogen and a C₁-C₆ hydrocarbyl group, n is an integer in the range of from 6 to 37, m is an integer in the range of from 12 to 74 and p is 0 or 1.

### DETAILED DESCRIPTION OF THE INVENTION

The liquid fuel composition of the present invention comprises a base fuel suitable for use in an internal combustion engine and one or more polyetheramines. The base fuel suitable for use in an internal combustion engine is a gasoline or a diesel fuel, and therefore the liquid fuel composition of the present invention is typically a gasoline composition or a diesel fuel composition.

The polyetheramine used in the present invention may also be referred to as a hyperdispersant.

The one or more polyetheramines in the liquid fuel compositions of the present invention are compounds having formula (I):

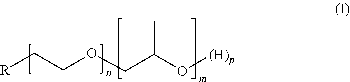

wherein R is an —NR¹₂ group where R¹ is independently selected from hydrogen and a C₁-C₆ hydrocarbyl group, n is in the range of from 6 to 37, m is in the range of from 12 to 74 and p is 0 or 1.

In formula (I), n is preferably in the range of from 8 to 24 and m is preferably in the range of from 16 to 48. In preferred embodiments, the ratio of n:m is 1:2.

In one embodiment of the present invention, p is 1. In another embodiment of the present invention p is 0.

In formula (I), R is a terminal amine group wherein the terminal amine group is selected from —NR¹₂, wherein R¹ is selected from hydrogen and a C₁-C₆ hydrocarbyl group.

The R¹ group in the terminal amine group is preferably independently selected from hydrogen and a C₁-C₄ hydrocarbyl group; more preferably R¹ is independently selected from a C₁-C₄ alkyl group. Examples of suitable C₁-C₄ alkyl groups are methyl, ethyl, n-propyl, i-propyl, n-butyl, i-butyl and t-butyl groups.

Examples of suitable terminal amine groups include —NH₂, —NHCH₃, —NHCH₂CH₃, —NHCH₂CH₂CH₃, —NHCH(CH₃)₂, —NHCH₂CH₂CH₂CH₃, —NHC(CH₃)₃, —N(CH₃)₂, —N(CH₃)CH₂CH₃, —N(CH₃)CH₂CH₂CH₃, —N(CH₂CH₃)₂, —N(CH₂CH₃)CH(CH₃)₂, —N(CH₂CH₃)CH₂CH₂CH₂CH₃, —N(CH₂CH₃)C(CH₃)₃, —N(CH₂CH₃)CH₂CH₃, —N(CH₂CH₃)CH₂CH₂CH₃, —N(CH₂CH₃)CH(CH₃)₂, —N(CH₂CH₃)CH₂CH₂CH₂CH₃, —N(CH₂CH₃)C(CH₃)₃, —N(CH(CH₃)₂)CH₂CH₂CH₃, —N(CH(CH₃))₂, —N(CH(CH₃)₂)CH₂CH₂CH₂CH₃, —N(CH(CH₃)₂)C(CH₃)₃, —N(CH₂CH₂CH₃)CH₂CH₃, —N(CH₂CH₂CH₃)₂, —N(CH₂CH₂CH₃)CH₂CH₂CH₂CH₃, —N(CH₂CH₂CH₃)C(CH₃)₃, —N(CH₂CH₂CH₂CH₃)₂, —N(CH₂CH₂CH₂CH₃)C(CH₃)₃, and —N(C(CH₃)₃)₂.

In a preferred embodiment of the present invention the terminal amine group is —N(CH₂CH₃)₂. In another preferred embodiment the terminal amine group is —NHCH₂CH₃.

As used herein, the term “hydrocarbyl” represents a radical formed by removal of one or more hydrogen atoms from a carbon atom of a hydrocarbon (not necessarily the same carbon atoms in case more hydrogen atoms are removed).

Hydrocarbyl groups may be aromatic, aliphatic, acyclic or cyclic groups. Preferably, hydrocarbyl groups are aryl, cycloalkyl, alkyl or alkenyl, in which case they may be straight-chain or branched-chain groups.

In the present invention, the phrase “optionally substituted hydrocarbyl” is used to describe hydrocarbyl groups optionally containing one or more “inert” heteroatom-containing functional groups. By “inert” is meant that the functional groups do not interfere to any substantial degree with the function of the compound.

The preparation of compounds of formula (I) is known and is described in the art, for example in WO96/00440. Examples of polyetheramines suitable for use herein include CH-10S commercially available from Shanghai Sanzheng Polymer Material Co. Ltd (China) and Solsperse (RTM) 20000 commercially available from Lubrizol Advanced Materials Inc.

In the liquid fuel compositions of the present invention, if the base fuel used is a gasoline, then the gasoline may be any gasoline suitable for use in an internal combustion engine of the spark-ignition (petrol) type known in the art. The gasoline used as the base fuel in the liquid fuel composition of the present invention may conveniently also be referred to as ‘base gasoline’.

Gasolines typically comprise mixtures of hydrocarbons boiling in the range from 25 to 230° C. (EN-ISO 3405), the optimal ranges and distillation curves typically varying according to climate and season of the year. The hydrocarbons in a gasoline may be derived by any means known in the art, conveniently the hydrocarbons may be derived in any known manner from straight-run gasoline, synthetically-produced aromatic hydrocarbon mixtures, thermally or catalytically cracked hydrocarbons, hydro-cracked petroleum fractions, catalytically reformed hydrocarbons or mixtures of these.

The specific distillation curve, hydrocarbon composition, research octane number (RON) and motor octane number (MON) of the gasoline are not critical.

Conveniently, the research octane number (RON) of the gasoline may be at least 80, for instance in the range of from 80 to 110, preferably the RON of the gasoline will be at least 90, for instance in the range of from 90 to 110, more preferably the RON of the gasoline will be at least 91, for instance in the range of from 91 to 105, even more preferably the RON of the gasoline will be at least 92, for instance in the range of from 92 to 103, even more preferably the RON of the gasoline will be at least 93, for instance in the range of from 93 to 102, and most preferably the RON of the gasoline will be at least 94, for instance in the range of from 94 to 100 (EN 25164); the motor octane number (MON) of the gasoline may conveniently be at least 70, for instance in the range of from 70 to 110, preferably the MON of the gasoline will be at least 75, for instance in the range of from 75 to 105, more preferably the MON of the gasoline will be at least 80, for instance in the range of from 80 to 100, most preferably the MON of the gasoline will be at least 82, for instance in the range of from 82 to 95 (EN 25163).

Typically, gasolines comprise components selected from one or more of the following groups; saturated hydrocarbons, olefinic hydrocarbons, aromatic hydrocarbons, and oxygenated hydrocarbons. Conveniently, the gasoline may comprise a mixture of saturated hydrocarbons, olefinic hydrocarbons, aromatic hydrocarbons, and, optionally, oxygenated hydrocarbons.

Typically, the olefinic hydrocarbon content of the gasoline is in the range of from 0 to 40 percent by volume based on the gasoline (ASTM D1319); preferably, the olefinic hydrocarbon content of the gasoline is in the range of from 0 to 30 percent by volume based on the gasoline, more preferably, the olefinic hydrocarbon content of the gasoline is in the range of from 0 to 20 percent by volume based on the gasoline.

Typically, the aromatic hydrocarbon content of the gasoline is in the range of from 0 to 70 percent by volume based on the gasoline (ASTM D1319), for instance the aromatic hydrocarbon content of the gasoline is in the range of from 10 to 60 percent by volume based on the gasoline; preferably, the aromatic hydrocarbon content of the gasoline is in the range of from 0 to 50 percent by volume based on the gasoline, for instance the aromatic hydrocarbon content of the gasoline is in the range of from 10 to 50 percent by volume based on the gasoline.

The benzene content of the gasoline is at most 10 percent by volume, more preferably at most 5 percent by volume, especially at most 1 percent by volume based on the gasoline.

The gasoline preferably has a low or ultra low sulphur content, for instance at most 1000 ppmw (parts per million by weight), preferably no more than 500 ppmw, more preferably no more than 100, even more preferably no more than 50 and most preferably no more than even 10 ppmw.

The gasoline also preferably has a low total lead content, such as at most 0.005 g/l, most preferably being lead free—having no lead compounds added thereto (i.e. unleaded).

When the gasoline comprises oxygenated hydrocarbons, at least a portion of non-oxygenated hydrocarbons will be substituted for oxygenated hydrocarbons. The oxygen content of the gasoline may be up to 35 percent by weight (EN 1601) (e.g. ethanol per se) based on the gasoline. For example, the oxygen content of the gasoline may be up to 25 percent by weight, preferably up to 10 percent by weight. Conveniently, the oxygenate concentration will have a minimum concentration selected from any one of 0, 0.2, 0.4, 0.6, 0.8, 1.0, and 1.2 percent by weight, and a maximum concentration selected from any one of 5, 4.5, 4.0, 3.5, 3.0, and 2.7 percent by weight.

Examples of oxygenated hydrocarbons that may be incorporated into the gasoline include alcohols, ethers, esters, ketones, aldehydes, carboxylic acids and their derivatives, and oxygen containing heterocyclic compounds. Preferably, the oxygenated hydrocarbons that may be incorporated into the gasoline are selected from alcohols (such as methanol, ethanol, propanol, 2-propanol, butanol, tert-butanol, iso-butanol and 2-butanol), ethers (preferably ethers containing 5 or more carbon atoms per molecule, e.g., methyl tert-butyl ether) and esters (preferably esters containing 5 or more carbon atoms per molecule); a particularly preferred oxygenated hydrocarbon is ethanol.

When oxygenated hydrocarbons are present in the gasoline, the amount of oxygenated hydrocarbons in the gasoline may vary over a wide range. For example, gasolines comprising a major proportion of oxygenated hydrocarbons are currently commercially available in countries such as Brazil and U.S.A, e.g. ethanol per se and E85, as well as gasolines comprising a minor proportion of oxygenated hydrocarbons, e.g. E10 and E5. Therefore, the gasoline may contain up to 100 percent by volume oxygenated hydrocarbons. Preferably, the amount of oxygenated hydrocarbons present in the gasoline is selected from one of the following amounts: up to 85 percent by volume; up to 65 percent by volume; up to 30 percent by volume; up to 20 percent by volume; up to 15 percent by volume; up to 10 percent by volume; up to 5 percent by volume; and up to 4 percent by volume, depending upon the desired final formulation of the gasoline. Conveniently, the gasoline may contain at least 0.5, 1.0 or 2.0 percent by volume oxygenated hydrocarbons.

Examples of suitable gasolines include gasolines which have an olefinic hydrocarbon content of from 0 to 20 percent by volume (ASTM D1319), an oxygen content of from 0 to 5 percent by weight (EN 1601), an aromatic hydrocarbon content of from 0 to 50 percent by volume (ASTM D1319) and a benzene content of at most 1 percent by volume.

Whilst not critical to the present invention, the base gasoline or the gasoline composition of the present invention may conveniently additionally include one or more fuel additive. The concentration and nature of the fuel additive(s) that may be included in the base gasoline or the gasoline composition of the present invention is not critical. Non-limiting examples of suitable types of fuel additives that can be included in the base gasoline or the gasoline composition of the present invention include anti-oxidants, corrosion inhibitors, detergents, dehazers, antiknock additives, metal deactivators, valve-seat recession protectant compounds, dyes, friction modifiers, carrier fluids, diluents and markers. Examples of suitable such additives are described generally in U.S. Pat. No. 5,855,629.

Conveniently, the fuel additives can be blended with one or more diluents or carrier fluids, to form an additive concentrate, the additive concentrate can then be admixed with the base gasoline or the gasoline composition of the present invention.

The (active matter) concentration of any additives present in the base gasoline or the gasoline composition of the present invention is preferably up to 1 percent by weight, more preferably in the range from 5 to 1000 ppmw, advantageously in the range of from 75 to 300 ppmw, such as from 95 to 150 ppmw.

In the liquid fuel compositions of the present invention, if the base fuel used is a diesel fuel, then the diesel fuel used as the base fuel in the present invention includes diesel fuels for use in automotive compression ignition engines, as well as in other types of engine such as for example marine, railroad and stationary engines. The diesel fuel used as the base fuel in the liquid fuel composition of the present invention may conveniently also be referred to as ‘diesel base fuel’.

The diesel base fuel may itself comprise a mixture of two or more different diesel fuel components, and/or be additivated as described below.

Such diesel fuels will contain one or more base fuels which may typically comprise liquid hydrocarbon middle distillate gas oil(s), for instance petroleum derived gas oils. Such fuels will typically have boiling points within the usual diesel range of 150 to 400° C., depending on grade and use. They will typically have a density from 750 to 1000 kg/m³, preferably from 780 to 860 kg/m³, at 15° C. (e.g. ASTM D4502 or IP 365) and a cetane number (ASTM D613) of from 35 to 120, more preferably from 40 to 85. They will typically have an initial boiling point in the range 150 to 230° C. and a final boiling point in the range 290 to 400° C. Their kinematic viscosity at 40° C. (ASTM D445) might suitably be from 1.2 to 4.5 mm²/s.

An example of a petroleum derived gas oil is a Swedish Class 1 base fuel, which will have a density from 800 to 820 kg/m³ at 15° C. (SS-EN ISO 3675, SS-EN ISO 12185), a T95 of 320° C. or less (SS-EN ISO 3405) and a kinematic viscosity at 40° C. (SS-EN ISO 3104) from 1.4 to 4.0 mm²/s, as defined by the Swedish national specification EC1.

Optionally, non-mineral oil based fuels, such as biofuels or Fischer-Tropsch derived fuels, may also form or be present in the diesel fuel. Such Fischer-Tropsch fuels may for example be derived from natural gas, natural gas liquids, petroleum or shale oil, petroleum or shale oil processing residues, coal or biomass.

The amount of Fischer-Tropsch derived fuel used in the diesel fuel may be from 0% to 100% v of the overall diesel fuel, preferably from 5% to 100% v, more preferably from 5% to 75% v. It may be desirable for such a diesel fuel to contain 10% v or greater, more preferably 20% v or greater, still more preferably 30% v or greater, of the Fischer-Tropsch derived fuel. It is particularly preferred for such diesel fuels to contain 30 to 75% v, and particularly 30 or 70% v, of the Fischer-Tropsch derived fuel. The balance of the diesel fuel is made up of one or more other diesel fuel components.

Such a Fischer-Tropsch derived fuel component is any fraction of the middle distillate fuel range, which can be isolated from the (optionally hydrocracked) Fischer-Tropsch synthesis product. Typical fractions will boil in the naphtha, kerosene or gas oil range. Preferably, a Fischer-Tropsch product boiling in the kerosene or gas oil range is used because these products are easier to handle in for example domestic environments. Such products will suitably comprise a fraction larger than 90 wt % which boils between 160 and 400° C., preferably to about 370° C. Examples of Fischer-Tropsch derived kerosene and gas oils are described in EP-A-0583836, WO-A-97/14768, WO-A-97/14769, WO-A-00/11116, WO-A-00/11117, WO-A-01/83406, WO-A-01/83648, WO-A-01/83647, WO-A-01/83641, WO-A-00/20535, WO-A-00/20534, EP-A-1101813, U.S. Pat. No. 5,766,274, U.S. Pat. No. 5,378,348, U.S. Pat. No. 5,888,376 and U.S. Pat. No. 6,204,426.

The Fischer-Tropsch product will suitably contain more than 80 wt % and more suitably more than 95 wt % iso and normal paraffins and less than 1 wt % aromatics, the balance being naphthenics compounds. The content of sulphur and nitrogen will be very low and normally below the detection limits for such compounds. For this reason the sulphur content of a diesel fuel composition containing a Fischer-Tropsch product may be very low.

The diesel fuel composition preferably contains no more than 5000 ppmw sulphur, more preferably no more than 500 ppmw, or no more than 350 ppmw, or no more than 150 ppmw, or no more than 100 ppmw, or no more than 70 ppmw, or no more than 50 ppmw, or no more than 30 ppmw, or no more than 20 ppmw, or most preferably no more than 15 ppmw sulphur.

The diesel base fuel may itself be additivated (additive-containing) or unadditivated (additive-free). If additivated, e.g. at the refinery, it will contain minor amounts of one or more additives selected for example from anti-static agents, pipeline drag reducers, flow improvers (e.g. ethylene/vinyl acetate copolymers or acrylate/maleic anhydride copolymers), lubricity additives, antioxidants and wax anti-settling agents.

Detergent-containing diesel fuel additives are known and commercially available. Such additives may be added to diesel fuels at levels intended to reduce, remove, or slow the build-up of engine deposits.

Examples of detergents suitable for use in diesel fuel additives for the present purpose include polyolefin substituted succinimides or succinamides of polyamines, for instance polyisobutylene succinimides or polyisobutylene amine succinamides, aliphatic amines, Mannich bases or amines and polyolefin (e.g. polyisobutylene) maleic anhydrides. Succinimide dispersant additives are described for example in GB-A-960493, EP-A-0147240, EP-A-0482253, EP-A-0613938, EP-A-0557516 and WO-A-98/42808. Particularly preferred are polyolefin substituted succinimides such as polyisobutylene succinimides.

The diesel fuel additive mixture may contain other components in addition to the detergent. Examples are lubricity enhancers; dehazers, e.g. alkoxylated phenol formaldehyde polymers; anti-foaming agents (e.g. polyether-modified polysiloxanes); ignition improvers (cetane improvers) (e.g. 2-ethylhexyl nitrate (EHN), cyclohexyl nitrate, di-tert-butyl peroxide and those disclosed in U.S. Pat. No. 4,208,190 at column 2, line 27 to column 3, line 21); anti-rust agents (e.g. a propane-1,2-diol semi-ester of tetrapropenyl succinic acid, or polyhydric alcohol esters of a succinic acid derivative, the succinic acid derivative having on at least one of its alpha-carbon atoms an unsubstituted or substituted aliphatic hydrocarbon group containing from 20 to 500 carbon atoms, e.g. the pentaerythritol diester of polyisobutylene-substituted succinic acid); corrosion inhibitors; reodorants; anti-wear additives; anti-oxidants (e.g. phenolics such as 2,6-di-tert-butylphenol, or phenylenediamines such as N,N′-di-sec-butyl-p-phenylenediamine); metal deactivators; combustion improvers; static dissipator additives; cold flow improvers; and wax anti-settling agents.

The diesel fuel additive mixture may contain a lubricity enhancer, especially when the diesel fuel composition has a low (e.g. 500 ppmw or less) sulphur content. In the additivated diesel fuel composition, the lubricity enhancer is conveniently present at a concentration of less than 1000 ppmw, preferably between 50 and 1000 ppmw, more preferably between 70 and 1000 ppmw. Suitable commercially available lubricity enhancers include ester- and acid-based additives. Other lubricity enhancers are described in the patent literature, in particular in connection with their use in low sulphur content diesel fuels, for example in:
the paper by Danping Wei and H. A. Spikes, “The Lubricity of Diesel Fuels”, Wear, III (1986) 217-235;
WO-A-95/33805—cold flow improvers to enhance lubricity of low sulphur fuels;
WO-A-94/17160—certain esters of a carboxylic acid and an alcohol wherein the acid has from 2 to 50 carbon atoms and the alcohol has 1 or more carbon atoms, particularly glycerol monooleate and di-isodecyl adipate, as fuel additives for wear reduction in a diesel engine injection system;
U.S. Pat. No. 5,490,864—certain dithiophosphoric diester-dialcohols as anti-wear lubricity additives for low sulphur diesel fuels; and
WO-A-98/01516—certain alkyl aromatic compounds having at least one carboxyl group attached to their aromatic nuclei, to confer anti-wear lubricity effects particularly in low sulphur diesel fuels.

It may also be preferred for the diesel fuel composition to contain an anti-foaming agent, more preferably in combination with an anti-rust agent and/or a corrosion inhibitor and/or a lubricity enhancing additive.

Unless otherwise stated, the (active matter) concentration of each such additive component in the additivated diesel fuel composition is preferably up to 10000 ppmw, more preferably in the range from 0.1 to 1000 ppmw, advantageously from 0.1 to 300 ppmw, such as from 0.1 to 150 ppmw.

The (active matter) concentration of any dehazer in the diesel fuel composition will preferably be in the range from 0.1 to 20 ppmw, more preferably from 1 to 15 ppmw, still more preferably from 1 to 10 ppmw, and especially from 1 to 5 ppmw. The (active matter) concentration of any ignition improver present will preferably be 2600 ppmw or less, more preferably 2000 ppmw or less, even more preferably 300 to 1500 ppmw. The (active matter) concentration of any detergent in the diesel fuel composition will preferably be in the range from 5 to 1500 ppmw, more preferably from 10 to 750 ppmw, most preferably from 20 to 500 ppmw.

In the case of a diesel fuel composition, for example, the fuel additive mixture will typically contain a detergent, optionally together with other components as described above, and a diesel fuel-compatible diluent, which may be a mineral oil, a solvent such as those sold by Shell companies under the trade mark “SHELLSOL”, a polar solvent such as an ester and, in particular, an alcohol, e.g. hexanol, 2-ethylhexanol, decanol, isotridecanol and alcohol mixtures such as those sold by Shell companies under the trade mark “LINEVOL”, especially LINEVOL 79 alcohol which is a mixture of C₇₋₉ primary alcohols, or a C₁₂₋₁₄ alcohol mixture which is commercially available.

The total content of the additives in the diesel fuel composition may be suitably between 0 and 10000 ppmw and preferably below 5000 ppmw.

In the above, amounts (concentrations, % vol, ppmw, % wt) of components are of active matter, i.e. exclusive of volatile solvents/diluent materials.

The liquid fuel composition of the present invention is produced by admixing the one or more polyetheramines of formula (I) with a base fuel suitable for use in an internal combustion engine. If the base fuel to which the one or more compounds of formula (I) is admixed is a gasoline, then the liquid fuel composition produced is a gasoline composition; likewise, if the base fuel to which the one or more compounds of formula (I) is admixed is a diesel fuel, then the liquid fuel composition produced is a diesel fuel composition.

Preferably, the amount of the one or more polyetheramines of formula (I) present in the liquid fuel composition of the present invention is at least 1 ppmw (part per million by weight), based on the overall weight of the liquid fuel composition. More preferably, the amount of the one or more polyetheramines present in the liquid fuel composition of the present invention additionally accords with one or more of the parameters (i) to (xx) listed below:
(i) at least 10 ppmw
(ii) at least 20 ppmw
(iii) at least 30 ppmw
(iv) at least 40 ppmw
(v) at least 50 ppmw
(vi) at least 60 ppmw
(vii) at least 70 ppmw
(viii) at least 80 ppmw
(ix) at least 90 ppmw
(x) at least 100 ppmw
(xi) at least 1000 ppmw
(xii) at most 20% wt.
(xiii) at most 18% wt.
(xiv) at most 16% wt.
(xv) at most 14% wt.
(xvi) at most 12% wt.
(xvii) at most 10% wt.
(xviii) at most 8% wt.
(xix) at most 6% wt.
(xx) at most 4% wt.
(xxi) at most 2% wt.

Conveniently, the amount of the one or more polyetheramines of formula (I) present in the liquid fuel composition of the present invention may also be at least 200 ppmw, at least 300 ppmw, at least 400 ppmw, at least 500 ppmw, or even at least 1000 ppmw.

It has surprisingly been found that the use of the one or more polyetheramines of formula (I) in liquid fuel compositions can also provide benefits in terms of improved fuel economy of an internal combustion engine being fuelled by the liquid fuel composition of the present invention, in particular when the liquid fuel composition of the present invention is a gasoline composition, relative to the internal combustion engine being fuelled by the liquid base fuel.

The present invention therefore provides a method of improving the fuel economy performance of a liquid base fuel suitable for use in an internal combustion engine, comprising admixing one or more polyetheramine compounds of formula (I) with a major portion of the liquid base fuel suitable for use in an internal combustion engine.

Additionally, the use of the one or more polyetheramine compounds in liquid fuel compositions can also provide benefits in terms improving the lubricant performance of an internal combustion engine being fuelled by the liquid fuel composition of the present invention relative to the internal combustion engine being fuelled by the liquid base fuel.

In particular, the improvement in the lubricant performance of the internal combustion engine fuelled by a liquid fuel composition according to the present invention can be observed by the a reduction in the levels of sludge and varnish on specific engine parts, such as sludge on rocker arm covers, cam baffles, timing chain covers, oil pans, oil pan baffles, and valve decks, and varnish on piston skirts and cam baffles.

In particular, the use of the one or more polyetheramine compounds in a gasoline composition can provide benefits in terms inhibiting specific sludge and varnish deposit formation, as measured by ASTM D 6593-07, of an internal combustion engine being fuelled by the gasoline composition of the present invention relative to the internal combustion engine being fuelled by the gasoline base fuel.

Therefore, the present invention also provides a method of improving the performance of the lubricant of an internal combustion engine, said method comprising fuelling an internal combustion engine containing the engine lubricant with a liquid fuel composition according to the present invention.

It has additionally been observed that the use of the one or more polyetheramines of formula (I) in the liquid fuel compositions can provide significant benefits in terms of improved lubricity of the liquid fuel composition, in particular when the liquid fuel composition is gasoline, relative to the liquid base fuel.

By the term “improved/improving lubricity” used herein, it is meant that the wear scar produced using a high frequency reciprocating rig (HFRR) is reduced.

It has further been observed that the use of the one or more polyetheramines in liquid fuel compositions can also provide benefits in terms of engine cleanliness, in particular in terms of improved inlet valve deposit keep clean and/or injector nozzle keep clean performance, of an internal combustion engine being fuelled by the liquid fuel composition of the present invention relative to the internal combustion engine being fuelled by the liquid base fuel.

By the term “improved/improving inlet valve deposit keep clean performance”, it is meant that the weight of deposit formed on the inlet valve of the engine is reduced relative to the base fuel not containing the one or more polyetheramines.

By the term “improved/improving injector nozzle keep clean performance”, it is meant that the amount of deposit formed on the injector nozzle of the engine is reduced as measured by the loss of engine torque.

The present invention further provides a method of operating an internal combustion engine, which method involves introducing into a combustion chamber of the engine a liquid fuel composition according to the present invention.

The polyetheramines of formula (I) may also be conveniently used in lubricating compositions, in particular in automotive engine lubricating oil compositions. WO 2007/128740, which is incorporated herein by reference, discloses suitable lubricating base oils and additives to which the polyetheramines described above may be admixed.

Therefore, the present invention further provides a lubricating composition comprising:
a base oil; and
one or more polyetheramines having formula (I) above.

Typically, the one or more polyetheramines of formula (I) is present in the lubricating composition of the present invention in an amount in the range of from 0.1 to 10.0 wt. %, more preferably in an amount in the range of from 0.1 to 5.0 wt. %, based on the total weight of the lubricating composition. According to an especially preferred embodiment, the composition comprises less than 5.0 wt. %, preferably less than 2.0 wt. % of the polyetheramines of formula (I), based on the total weight of the lubricant composition.

Typically the lubricating composition has a relatively low phosphorus content such as below 0.12 wt. % (according to ASTM D 5185). Preferably, the composition has a phosphorus content of less than 0.08 wt. %. Preferably, the composition has a phosphorus content of above 0.06 wt. %.

Also, it is preferred that the composition has a sulphur content of less than 0.6 wt. % (according to ASTM D 5185).

Further it is preferred that the composition has a chlorine content of less than 200 ppm (according to ASTM D 808).

According to an especially preferred embodiment, the composition has an ash content of below 2.0 wt. % (according to ASTM D 874).

According to an especially preferred embodiment of the present invention, the composition comprises a zinc dialkyl dithiophosphate (ZDDP) compound. Typically, if present, the ZDDP compound is present in an amount of 0.01-1.5 wt. %, preferably 0.4-1.0 wt. %. The ZDDP compound may have been made from primary, secondary, tertiary alcohols or mixtures thereof, preferably containing less than 12 carbon atoms. Preferably, the ZDDP compound has been made from secondary alcohols containing 3 to 8 carbon atoms.

There are no particular limitations regarding the base oil used in the lubricating composition, and various conventional mineral oils, synthetic oils as well as naturally derived esters such as vegetable oils may be conveniently used.

The base oil used may conveniently comprise mixtures of one or more mineral oils and/or one or more synthetic oils; thus, the term “base oil” may refer to a mixture containing more than one base oil. Mineral oils include liquid petroleum oils and solvent-treated or acid-treated mineral lubricating oil of the paraffinic, naphthenic, or mixed paraffinic/naphthenic type which may be further refined by hydrofinishing processes and/or dewaxing.

Suitable base oils for use in the lubricating oil composition are Group I-III mineral base oils, Group IV poly-alpha olefins (PAOs), Group II-III Fischer-Tropsch derived base oils and mixtures thereof.

By “Group I”, “Group II”, “Group III” and “Group IV” base oils are meant lubricating oil base oils according to the definitions of American Petroleum Institute (API) for categories I-IV. These API categories are defined in API Publication 1509, 16th Edition, Appendix E, April 2007.

Fischer-Tropsch derived base oils are known in the art. By the term “Fischer-Tropsch derived” is meant that a base oil is, or is derived from, a synthesis product of a Fischer-Tropsch process. A Fischer-Tropsch derived base oil may also be referred to as a GTL (Gas-To-Liquids) base oil. Suitable Fischer-Tropsch derived base oils that may be conveniently used as the base oil in the lubricating composition are those as for example disclosed in EP 0 776 959, EP 0 668 342, WO 97/21788, WO 00/15736, WO 00/14188, WO 00/14187, WO 00/14183, WO 00/14179, WO 00/08115, WO 99/41332, EP 1 029 029, WO 01/18156 and WO 01/57166.

Synthetic oils include hydrocarbon oils such as olefin oligomers (including polyalphaolefin base oils; PAOs), dibasic acid esters, polyol esters, polyalkylene glycols (PAGs), alkyl naphthalenes and dewaxed waxy isomerates. Synthetic hydrocarbon base oils sold by the Shell Group under the designation “Shell XHVI” (trade mark) may be conveniently used.

Poly-alpha olefin base oils (PAOs) and their manufacture are well known in the art. Preferred poly-alpha olefin base oils that may be used in the lubricating compositions may be derived from linear C₂ to C₃₂, preferably C₆ to C₁₆, alpha olefins. Particularly preferred feedstocks for said poly-alpha olefins are 1-octene, 1-decene, 1-dodecene and 1-tetradecene.

The total amount of base oil incorporated in the lubricating composition is preferably present in an amount in the range of from 60 to 99 wt. %, more preferably in an amount in the range of from 65 to 98 wt. % and most preferably in an amount in the range of from 70 to 95 wt. %, with respect to the total weight of the lubricating composition.

Preferably, the finished lubricating composition has a kinematic viscosity in the range of from 2 to 80 mm²/s at 100° C., more preferably in the range of from 3 to 70 mm²/s, most preferably in the range of from 4 to 50 mm²/s.

The lubricating composition may further comprise additional additives such as anti-wear additives, anti-oxidants, dispersants, detergents, friction modifiers, viscosity index improvers, pour point depressants, corrosion inhibitors, defoaming agents and seal fix or seal compatibility agents.

As the person skilled in the art is familiar with the above and other additives, these are not further discussed here in detail. Specific examples of such additives are described in for example Kirk-Othmer Encyclopedia of Chemical Technology, third edition, volume 14, pages 477-526.

Preferably the detergent, if present, is selected from phenate- and sulphonate-type detergents; accordingly.

The lubricating compositions may be conveniently prepared by admixing the polyetheramine of formula (I), and, optionally, any further additives that are usually present in lubricating compositions, for example as herein before described, with mineral and/or synthetic base oil.

The use of polyetheramines of formula (I) in lubricating compositions can provide benefits in terms of improved lubricity of the lubricating composition.

Additionally, the use of polyetheramines, in lubricating compositions can provide benefits in terms inhibiting specific sludge and varnish deposit formation, as measured by ASTM D 6593-07.

Additionally, the use of polyetheramines of formula (I) in lubricating compositions can provide benefits in terms improving the fuel economy of an internal combustion engine lubricated by the lubricating composition.

The present invention will be further understood from the following examples. Unless otherwise stated, all amounts and concentrations disclosed in the examples are based on weight of the fully formulated fuel composition.

### Examples

### Examples 1 to 5 and Comparative Example A

In the following examples, a commercially available hyperdispersant, CH-10S, which is available from Shanghai Sanzheng Polymer Material Co Ltd (China), was used. The CH-10S hyperdispersant was blended into a gasoline base fuel described in Table 1 below, in various amounts.

TABLE 1
Gasoline Base Fuel Used in Examples 1 to 5 and Comparative Example A

| Parameter | “Gasoline” |
|---|---|
| RON (ASTM D2699) | 96.00 |
| MON (ASTM D2700) | 85.10 |
| Density at 15° C. (IP365) | 0.73 g/cm³ |
| IBP (IP123) | 26.5° C. |
| 10% rec. (IP123) | 37.9° C. |
| 20% rec. (IP123) | 48.9° C. |
| 30% rec. (IP123) | 61.0° C. |
| 40% rec. (IP123) | 74.4° C. |
| 50% rec. (IP123) | 88.2° C. |
| 60% rec. (IP123) | 101.4° C. |
| 70% rec. (IP123) | 113.3° C. |
| 80% rec. (IP123) | 127.9° C. |
| 90% rec. (IP123) | 149.2° C. |
| 95% rec. (IP123) | 164.7° C. |
| FBP (IP123) | 191.2° C. |
| RVP *(IP394) | 87.8 kPa |
| Olefins (inc. dienes) | 16.40% vol. |
| Aromatics | 28.88% vol. |

The lubricity of the gasoline compositions was determined by using a modified HFRR test. The modified HFRR test is based on ISO 12156-1 using a PCS Instruments HFRR supplemented with the PCS Instruments Gasoline Conversion Kit, and using a fluid volume of 15.0 ml (+/−0.2 ml), a fluid temperature of 25.0° C. (+/−1° C.), and wherein a PTFE cover is used to cover the test sample in order to minimise evaporation.

The results of the lubricity tests are given below in Table 2.

TABLE 2

| | Hyperdispersant | Average HFRR |
|---|---|---|
| Example | concentration | Wear Scar (μm) |
| A* | — | 861 |
| 1 | 1% | 608 |
| 2 | 1000 ppmw | 684 |
| 3 | 500 ppmw | 709 |
| 4 | 100 ppmw | 846 |
| 5 | 50 ppmw | 855 |

*Not according to the present invention.

As can be seen from the results in Table 2, a reduced wear scar is observed in the HFRR test for the fuel compositions containing the CH-10S hyperdispersant compared to the base fuel, which represents an improvement in lubricity of the fuels containing the CH-10S hyperdispersant compared to the base fuel.

### Example 6

The CH-10S hyperdispersant was subsequently tested in a vehicle on a chassis dynamometer by running the vehicle on lubricant containing CH-10S and comparing this with the vehicle run on an undosed lubricant. The vehicle used was a Honda Accord. The cycle used for all runs in this test was US Environmental Protection Agency Highway Fuel Economy Test Driving Schedule. The base fuel used was an EN228 compliant gasoline described in Table 3 below.

TABLE 3
Gasoline Base Fuel Used in Example 6

| | | |
|---|---|---|
| RON | 95 | — |
| MON | 86.8 | — |
| Density at 15 C | 734.3 | Kg/m3 |
| IBP | 29.7 | deg C. |
| 10% v/v | 46.1 | — |
| 20 | 54.8 | — |
| 30 | 63.5 | — |
| 40 | 72.3 | — |
| 50 | 81.5 | — |
| 60 | 91.7 | — |
| 70 | 107.4 | — |
| 80 | 132.7 | — |
| 90 | 153.3 | — |
| 95 | 168.8 | — |
| FBP | 184.8 | — |
| RVP | 92.1 | kPa |
| Paraffins | 47.5 | % vol |
| Olefins | 2.5 | % vol |
| Naphthenes | 7 | % vol |
| Aromatics | 29.4 | % vol |
| Sulphur | <10 | ppm |

12 repeat runs were carried out on the vehicle run on undosed lubricant. Then the lubricant was dosed with 2 wt % CH-10S hyperdispersant. A further 12 runs were then carried out. The results are shown in Table 4 below.

TABLE 4

| | Wt % of CH- | FC carb. | |
|---|---|---|---|
| | 10S in | Balance | FC grav. |
| Run | lubricant | (l/100 km) | (l/100 km) |
| 1 | 0 | 6.011998 | 5.738255 |
| 2 | 0 | 6.034323 | 5.748585 |
| 3 | 0 | 6.035841 | 5.749873 |
| 4 | 0 | 6.032325 | 5.747106 |
| 5 | 0 | 6.028831 | 5.749734 |
| 6 | 0 | 6.027147 | 5.752065 |
| 7 | 0 | 6.022109 | 5.754019 |
| 8 | 0 | 6.020437 | 5.748485 |
| 9 | 0 | 6.0146617 | 5.742208 |
| 10 | 0 | 6.016619 | 5.745111 |
| 11 | 0 | 6.014539 | 5.742413 |
| 12 | 0 | 6.024978 | 5.740052 |
| 13 | 2 | 6.018208 | 5.7200997 |
| 14 | 2 | 6.023106 | 5.732263 |
| 15 | 2 | 6.020504 | 5.733532 |
| 16 | 2 | 6.008882 | 5.722843 |
| 17 | 2 | 6.004768 | 5.720167 |
| 18 | 2 | 5.992259 | 5.710089 |
| 19 | 2 | 5.99758 | 5.727299 |
| 20 | 2 | 5.986352 | 5.719603 |
| 21 | 2 | 5.976652 | 5.709435 |
| 22 | 2 | 5.974417 | 5.709435 |
| 23 | 2 | 5.971033 | 5.7034 |
| 24 | 2 | 5.971932 | 5.706334 |

Statistical analysis of the data in Table 4 showed that a fuel economy benefit of around 0.5% was obtained on using lubricant dosed with 2 wt % CH-10S hyperdispersant compared to using undosed lubricant.

### Example 7

The fuel consumption and fuel economy benefit of using a lubricant dosed with 2 wt % CH-10S hyperdispersant was compared with that of an undosed lubricant by using a steady-state engine bench test. The test used a Ford Zetec 1.988 litre 4-cylinder inline DOHC petrol engine. The fuel used was 95 octane gasoline having the properties set out in Table 5. The lubricant used was Shell Helix 5W30.

TABLE 5

| | | |
|---|---|---|
| RON | 95.2 | |
| MON | 86.9 | |
| Density | 0.7292 | g/cm3 |
| IBP | 34.1 | C |
| FBP | 170.8 | C |
| E70 | 31.1 | % v |
| E100 | 57.1 | % v |
| E120 | 73.8 | $v |
| E150 | 96 | % v |
| RVP | 56.1 | kPa |

The engine was clean and free from abnormal levels of Inlet Valve Deposits (IVDs) and Combustion Chamber Deposits (CCDs). A power curve check was performed prior to the start of the tests. The fuel temperature was monitored to make sure it is constant (between 20-30° C.). The fuel pressure was controlled by the standard pressure regulators fitted to the engine's fuel manifold. Fuel rail pressure for this engine should be between 350 and 400 kPa. The test was based on the continuous repetition of the set of speed/load points shown in Table 6 (test cycle). The cycle was repeated over a total period of approximately 21 hours (16 hours overnight lubricant de-greening and 5 hours fuel consumption measurements) with scheduled breaks for the acquisition of lubricant samples and the injection of the crankcase additive. The 5-hour fuel consumption measurement period was made up of 30 cycles. The brake specific fuel consumption was measured using Schenk DC-101 test bench control software under four test conditions of speed and load as set out in Table 6. The results of the brake specific fuel consumption (BSFC) measurements are shown in Table 6 below.

TABLE 6

| wt % CH-10S | BSFC at | BSFC at | BSFC at | BSFC at |
|---|---|---|---|---|
| in | 1500 rpm | 1500 rpm | 3000 rpm | 3000 rpm |
| lubricant | 40 Nm | 79 Nm | 40 Nm | 70 Nm |
| 0* | −0.31 | 0.06 | 0.08 | 0.17 |
| 2 | 1.6 | 1.3 | 1.1 | 0.55 |

*Comparative Example

These results indicate that sump dosing 2 wt % of the CH-10S into the lubricant gives a fuel economy benefit.

1. A liquid fuel composition comprising:
(a) a base fuel suitable for use in an internal combustion engine which is a gasoline or a diesel fuel; and
(b) one or more polyetheramines having formula (I): 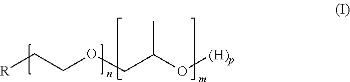
wherein R is an —NR¹₂ group where R¹ is independently selected from hydrogen and a C₁-C₆ hydrocarbyl group, n is an integer in the range of from 6 to 37, m is an integer in the range of from 12 to 74 and p is 1.

2. The liquid fuel composition of claim 1, wherein the amount of the polyetheramines present in the liquid fuel composition is at least 1 ppmw, based on the overall weight of the liquid fuel composition.

3. The liquid fuel composition of claim 1 wherein the amount of the polyetheramines present in the liquid fuel composition is in the range of from 10 ppmw to 20% wt, based on the overall weight of the liquid fuel composition.

4. The liquid fuel composition of claim 1, wherein R¹ is independently selected from a C₁-C₄ alkyl group.

5. A The liquid fuel composition as claimed in claim 4, wherein R¹ is C₂H₅.

6. A method of improving the fuel economy performance of a liquid base fuel suitable for use in an internal combustion engine which is a gasoline or a diesel fuel, said method comprising:
admixing one or more polyetheramines having formula (I): 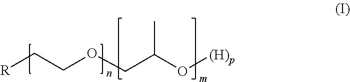
wherein R is an —NR¹₂ group where R¹ is independently selected from hydrogen and a C₁-C₆ hydrocarbyl group, n is an integer in the range of from 6 to 37, m is an integer in the range of from 12 to 74 and p is 1;
with a major portion of the liquid base fuel suitable for use in an internal combustion engine.

7. A method of improving the performance of the lubricant of an internal combustion engine, said method comprising fuelling an internal combustion engine containing the engine lubricant with a liquid fuel composition of claim 1.

8. The liquid fuel composition of claim 1 wherein the terminal amine group of the one or more polyetheramins is —NHCH₂CH₃.

9. A lubricant composition comprising:
(a) a base oil; and
(b) one or more polyetheramines having formula (I): 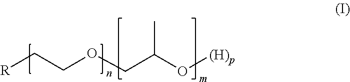
wherein R is an —NR¹₂ group where R¹ is independently selected from hydrogen and a C₁-C₆ hydrocarbyl group, n is an integer in the range of from 6 to 37, m is an integer in the range of from 12 to 74 and p is 0 or 1.

10. The lubricating oil composition of claim 8 wherein R¹ is independently selected from C₁-C₄ alkyl group.

11. The lubricating oil composition of claim 10 wherein the terminal amine group of the one or more polyethertueramine is —N(CH₂CH₃)₂.

12. The lubricating oil composition of claim 8 wherein the terminal amine group of the one or more polyetheramines is —NHCH₂CH₃.
